(19) United States
(12) Patent Application Publication
(10) Pub. No.: US 2022/0268593 A1
(43) Pub. Date: Aug. 25, 2022

(54) JOINT OPTIMIZATION OF VEHICLE MOBILITY, COMMUNICATION NETWORKS, AND COMPUTING RESOURCES

(71) Applicant: International Business Machines Corporation, Armonk, NY (US)

(72) Inventors: Sergio Cabrero Barros, Dublin (IE); Rodrigo Hernan Ordonez-Hurtado, Maynooth (IE); Claudio Gambella, Dublin (IE); Anton Dekusar, Dublin (IE); Martin Mevissen, Dublin (IE); Julien Monteil, Dublin (IE); Yassine Lassoued, Dublin (IE)

(21) Appl. No.: 17/179,926

(22) Filed: Feb. 19, 2021

(51) Int. Cl. G01C 21/34; G01C 21/32; G01C 21/00; H04W 24/02; H04W 28/24; H04L 29/08

(52) U.S. Cl. CPC G01C 21/3484; G01C 21/32; G01C 21/3492; G01C 21/3863; H04W 24/02; H04W 28/24; H04L 67/12

(57) ABSTRACT

A computer-implemented method, a computer program product, and a computer system for optimizing vehicle mobility, communication networks, and required computing resources for a connected vehicle. A computer applies user-defined settings to configure associated optimization algorithms. The computer aggregates data structures related to traveling distances, mobility metrics, and expected levels of Quality of Service (QoS) for one or more applications in a connected vehicle. The computer calculates an optimal route, given imposed constraints including points of interest and QoS requirements of the one or more applications. The computer prepares expected QoS of the one or more applications, recommended configurations of the one or more applications, and recommended configurations of one or more networks along the optimal route. The computer provides the connected vehicle with the optimal route, the recommended configurations of the one or more applications, and recommended the configurations of the one or more networks.

### BACKGROUND

The present invention relates generally to a vehicle routing service, and more particularly to joint optimization of vehicle mobility, communication networks, and required computing resources for a connected vehicle.

There is a proliferation of connected vehicles (for example cars, trucks, or drones) that are connected to a network and run applications that require connectivity. The connected vehicles make use of mobile networks and cloud services, which will be highly benefited from upcoming 5G edge computing resources. The connected vehicles run applications for many different purposes, including autonomous driving, driving assistance, or drone navigation systems. An application on a connected vehicle is a piece of software that may require or benefit from using network resources or Internet resources.

The performance of an application on a connected vehicle depends on the mobile network coverage, deployment, and capabilities along a route of the connected vehicle. Therefore, considering these above-mentioned factors in planning a route for the connected vehicle can reduce the uncertainty in the performance of the application on the connected vehicle and help selecting routes of high quality.

Existing vehicle routing services provide routes for vehicles based on traffic conditions, driving preferences and so on. So far, there are no mobility routing services that also consider communication requirements of applications running in connected vehicles.

### SUMMARY

In one aspect, a computer-implemented method for optimizing vehicle mobility, communication networks, and required computing resources for a connected vehicle is provided. The computer-implemented method includes applying user-defined settings to configure associated optimization algorithms. The computer-implemented method further includes aggregating data structures related to traveling distances, mobility metrics, and expected levels of Quality of Service (QoS) for one or more applications in a connected vehicle. The computer-implemented method further includes calculating an optimal route, given imposed constraints including points of interest and QoS requirements of the one or more applications. The computer-implemented method further includes preparing expected QoS of the one or more applications, recommended configurations of the one or more applications, and recommended configurations of one or more networks along the optimal route. The computer-implemented method further includes providing the connected vehicle with the optimal route, the recommended configurations of the one or more applications, and the recommended configurations of the one or more networks.

In another aspect, a computer program product for optimizing vehicle mobility, communication networks, and required computing resources for a connected vehicle is provided. The computer program product comprises a computer readable storage medium having program instructions embodied therewith, and the program instructions are executable by one or more processors. The program instructions are executable to: apply user-defined settings to configure associated optimization algorithms; aggregate data structures related to traveling distances, mobility metrics, and expected levels of Quality of Service (QoS) for one or more applications in a connected vehicle; calculate an optimal route, given imposed constraints including points of interest and QoS requirements of the one or more applications; prepare expected QoS of the one or more applications, recommended configurations of the one or more applications, and recommended configurations of one or more networks along the optimal route; and provide the connected vehicle with the optimal route, the recommended configurations of the one or more applications, and the recommended configurations of the one or more networks.

In yet another aspect, a computer system for optimizing vehicle mobility, communication networks, and required computing resources for a connected vehicle is provided. The computer system comprises one or more processors, one or more computer readable tangible storage devices, and program instructions stored on at least one of the one or more computer readable tangible storage devices for execution by at least one of the one or more processors. The program instructions are executable to apply user-defined settings to configure associated optimization algorithms. The program instructions are further executable to aggregate data structures related to traveling distances, mobility metrics, and expected levels of Quality of Service (QoS) for one or more applications in a connected vehicle. The program instructions are further executable to calculate an optimal route, given imposed constraints including points of interest and QoS requirements of the one or more applications. The program instructions are further executable to prepare expected QoS of the one or more applications, recommended configurations of the one or more applications, and recommended configurations of one or more networks along the optimal route. The program instructions are further executable to provide the connected vehicle with the optimal route, the recommended configurations of the one or more applications, and the recommended configurations of the networks.

In yet another aspect, a computer-implemented method for optimizing vehicle mobility, communication networks, and required computing resources for a connected vehicle is provided. The computer-implemented method includes computing a set of routes for a connected vehicle, based on a map and environmental conditions. The computer-implemented method further includes estimating, for respective ones of the routes, Quality of Service (QoS) performances of one or more applications in the connected vehicle, based on a mobile network model. The computer-implemented method further includes evaluating the respective ones of the routes, by considering mobility metrics, user preferences, and metrics of the one or more applications and one or more networks. The computer-implemented method further includes selecting, from the set of the routes, an optimal route accompanied with suggested configurations of the one or more applications, and suggested configurations of the one or more networks along the optimal route. The computer-implemented method further includes providing the connected vehicle with the optimal route, the suggested configurations of the one or more applications, and the suggested configurations of the one or more networks.

In yet another aspect, a computer program product for optimizing vehicle mobility, communication networks, and required computing resources for a connected vehicle is provided. The program instructions are executable to compute a set of routes for a connected vehicle, based on a map and environmental conditions. The program instructions are further executable to estimate, for respective ones of the routes, Quality of Service (QoS) performances of one or more applications in the vehicle, based on a mobile network model. The program instructions are further executable to evaluate the respective ones of the routes, by considering mobility metrics, user preferences, and metrics of the one or more applications and one or more networks. The program instructions are further executable to select, from the set of the routes, an optimal route accompanied with suggested configurations of the one or more applications, and suggested configurations of the one or more networks along the optimal route. The program instructions are further executable to provide the connected vehicle with the optimal route, the suggested configurations of the one or more applications, and the suggested configurations of the one or more networks.

### BRIEF DESCRIPTION OF THE SEVERAL VIEWS OF THE DRAWINGS

FIG. 1 is a systematic diagram illustrating a system for joint optimization of vehicle mobility, communication networks, and required computing resources for a connected vehicle, in accordance with one embodiment of the present invention.

FIG. 2 is a diagram illustrating an example of a graphical representation of a mobile network model, in accordance with one embodiment of the present invention.

FIG. 3 is a diagram illustrating an example of considering network connectivity in determining an optimal route using multi-objective optimization, in accordance with one embodiment of the present invention.

FIG. 4 presents a flowchart showing operational steps for joint optimization of vehicle mobility, communication networks, and required computing resources for a connected vehicle, in accordance with one embodiment of the present invention.

FIG. 5 is a systematic diagram illustrating a system for sub-optimal solution with lower computing complexity, in accordance with one embodiment of the present invention.

FIG. 6 presents a flowchart showing operational steps of sub-optimal solution with lower computing complexity, in accordance with one embodiment of the present invention.

FIG. 7 is a diagram illustrating components of a computing device or server, in accordance with one embodiment of the present invention.

FIG. 8 depicts a cloud computing environment, in accordance with one embodiment of the present invention.

FIG. 9 depicts abstraction model layers in a cloud computing environment, in accordance with one embodiment of the present invention.

### DETAILED DESCRIPTION

In this document, a connected vehicle is a vehicle (such as a car, a truck, or a drone) that is connected to one or more networks and runs one or more applications that require connectivity. A respective one of the one or more applications is a piece of software running in the connected vehicle; it may require or benefit from resources of the one or more networks. QoS (Quality of Service) is a set of measurements or requirements that define performances of the one or more applications and the one or more networks. A mobile network model is a model, for given locations and times, that provides estimations or predictions of QoS performance metrics (e.g., latency, bitrate, etc.) for the one or more networks and/or the one or more applications using the one or more networks.

Embodiments of the present invention disclose an approach of selecting an optimal route that best complies with a set of mobility, connectivity, and computing requirements according to user preferences and mobile network availability. Embodiments of the present invention combine mobility routing and mobile network management methods and technologies. In embodiments of the present invention, vehicle routes in combination with application configurations and network configurations are generated, and they respond to the reality of the influence of mobility on performances of modern software applications.

The latest developments and the expected future advances in the mobility and communications industries advocate the adoption of the present invention. Trends in the mobility landscape that depend on distributed computing and network connectivity capabilities include but not limited to: (1) advances in the field of connected and automated driving (CAD), such as higher levels of automation in commercial vehicles; (2) new types of connected and automated vehicles (CAVs), such as drones, unmanned aerial vehicles (UAVs), trucks, delivery robots, and factory robots; and (3) deployment of mobility IoT infrastructure, such as traffic cameras, light detection and ranging (LIDAR), parking sensors, and road-side units (RSUs).

Furthermore, an increased number of 5G technologies are constantly being deployed. The 5G technologies will add some interesting features for the one or more applications in the mobility space, including but not limited to: (1) new wireless interfaces which enable higher bitrates and lower latencies; (2) computation and storage in the network (edge) that provide lower latency and savings in bandwidth; and (3) dynamic network resource configuration (software defined networks/radio, slicing) that enables efficient resource management and more stable QoS; for example, networks can move resources to follow vehicles and prediction of application QoS or network congestion is easier.

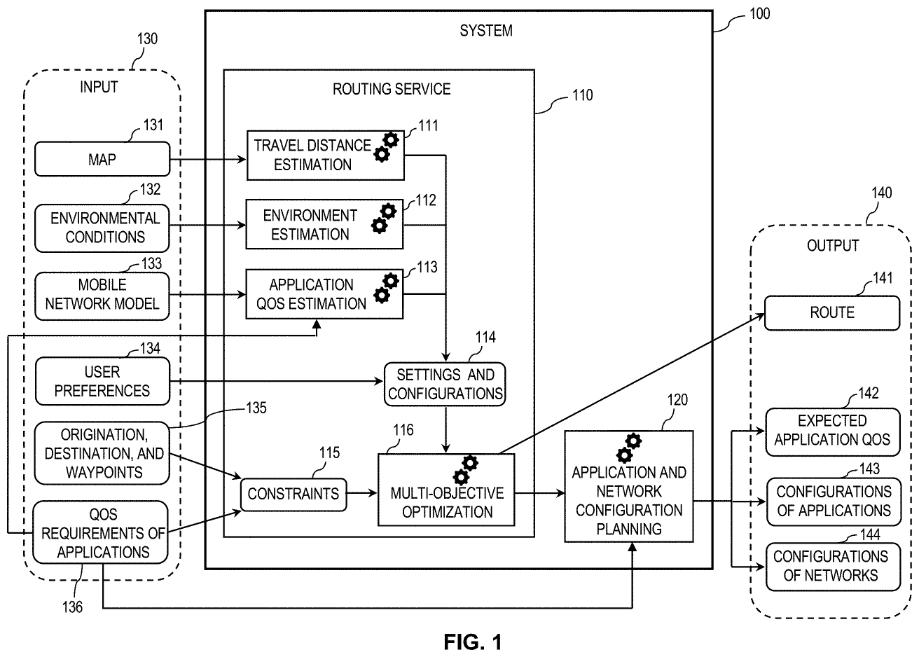

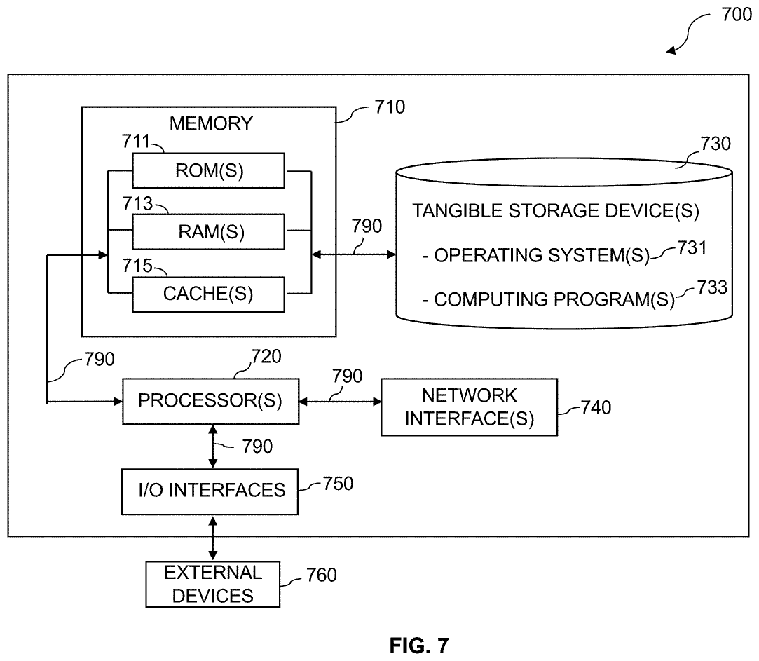

FIG. 1 is a systematic diagram illustrating “System” 100 for joint optimization of vehicle mobility, communication networks, and required computing resources for a connected vehicle, in accordance with one embodiment of the present invention. In some embodiments, “System” 100 may reside on one or more computing devices in the connected vehicle. In other embodiments, “System” 100 may reside on one or more computing devices or server in a network. A computing device or server is described in more detail in later paragraphs with reference to FIG. 7.

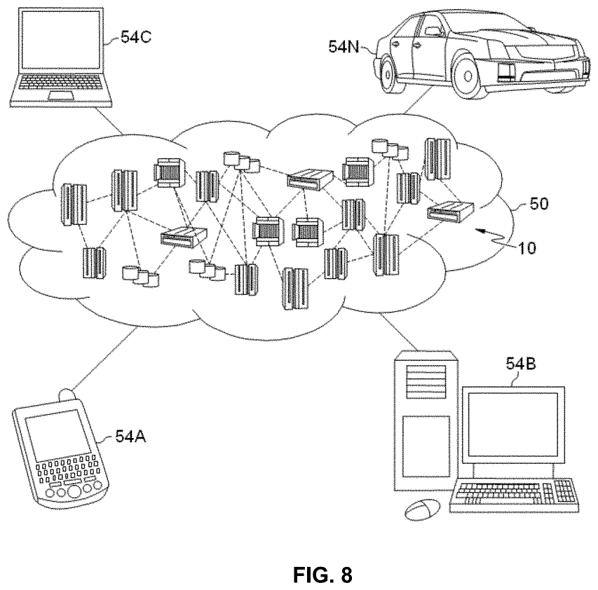

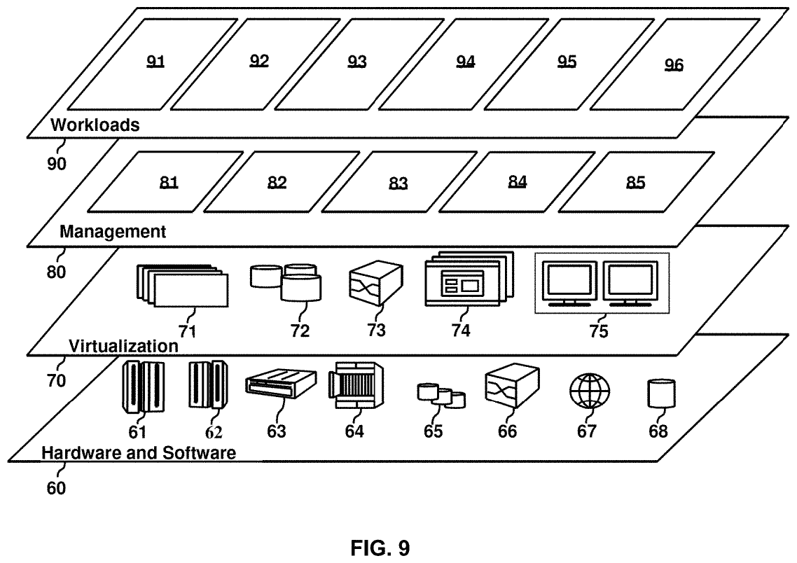

“System” 100 may be implemented in a network that can be any combination of connections and protocols which supports communications among one or more computing devices or servers. For example, the network may be the Internet which represents a worldwide collection of networks and gateways to support communications between devices connected to the Internet; the network may be implemented as an intranet, a local area network (LAN), a wide area network (WAN), and/or a wireless network. “System” 100 may be implemented in a cloud computing environment. Later paragraphs with reference to FIG. 8 and FIG. 9 describe the cloud computing environment in detail.

Referring to FIG. 1, “System” 100 includes “Routing Service” 110 and “Application and Network Configuration Planning” 120. “Routing Service” 110 includes modules of “Travel Distance Estimation” 111, “Environment Estimation” 112, “Application QoS (Quality of Service) Estimation” 113, “Settings and Configurations” 114, “Constraints” 115, and “Multi-Objective Optimization” 116. “System” 100 receives “Input” 130 and provides “Output” 140. In “System” 100, “Travel Distance Estimation” 111, “Environment Estimation” 112, “Application QoS (Quality of Service) Estimation” 113, “Multi-Objective Optimization” 116, and “Network Configuration Planning” 120 perform analytics on “Input” 130 or outputs of other modules.

“Input” 130 includes “Map” 131. “Map” 131 provides a 2D and/or 3D geographical characterization of an area in which a vehicle will travel. “Input” 130 further includes “Environmental Conditions” 132 which may include variables that affect mobility of a vehicle or experience of a user related to mobility. For example, environmental conditions are traffic information such as road closures, traffic jams, scheduled events, and current weather, and environmental conditions may also include forecasted traffic situation, weather forecasts, or other environmental conditions.

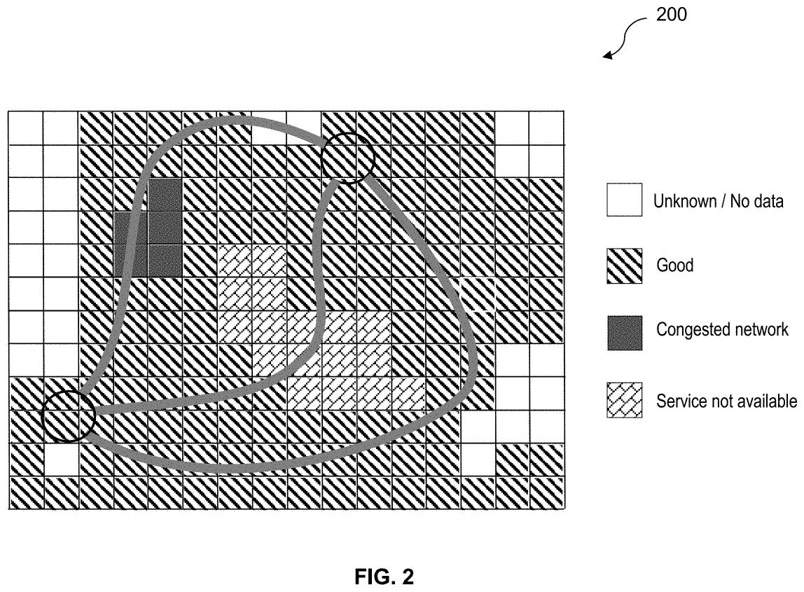

“Input” 130 further includes “Mobile Network Model” 133. “Mobile Network Model” 133 is a function that provides estimations of one or more QoS metrics, given a location and optionally a time if “Mobile Network Model” 133 predicts future QoS (Quality of Service) metrics. The estimations of the one or more QoS metrics may be generic for any application running via a network (e.g., bitrate available per user), while the estimations of the one or more QoS metrics may be specific to different applications (e.g., bitrate available per user for streaming a video in one application and latency to an application server of a service). In a case where deployment of a network is well known, a mobile network model may be built by combining such deployment with existing models for network coverage (signal propagation models), e.g., based on simulations/emulations. In a case where whole or part of deployment of a network is unknown, a mobile network model may be built by using active or passive measurements of the network, i.e., trace based. A mobile network model may be represented as a graph or using the data structure more suitable for the purpose. FIG. 2 is a diagram illustrating graphical representation 200 of a mobile network model, in accordance with one embodiment of the present invention.

“Input” 130 further includes “User Preferences” 134. For example, “User Preferences” 134 include but not limited to a level of autonomous driving, a vehicle type (e.g., a bike, a personal vehicle, or a public vehicle), a preferred arrival/departure time, road tolls, preferred vehicle applications.

“Input” 130 further includes “Origination, Destination, and Waypoints” 135 which may provide an initial location and a destination location of traveling of a vehicle and may further provide points of interest to be visited (either in ordered or not) in traveling by a vehicle. Waypoints may be provided as alternative or additional input to an origin and destination pair.

“Input” 130 further includes “QoS Requirements of Applications” 136. QoS (Quality of Service) requirements vary according to the type of an application, and QoS requirements include but not limited to latency, constant or variable bitrate, required GPU (graphics processing unit) or CPU (central processing unit) computation time, and storage. In a case of adaptive applications, sets of requirements can be requested; for example, best performance QoS constraints may be bandwidth >1 Mbps and latency <30 ms, and acceptable performance QoS constraints may be bandwidth >500 Kbps and latency <50 ms. These preferences may be weighted accordingly in a multi-objective optimization algorithm.

“Output” 140 includes “Route” 141 which is a best route for a vehicle and recommended by “System” 100. “Output” 140 further includes “Expected Application QoS (Quality of Service)” 142 which is expected performances of respective ones of the applications and is forecasted by “System” 100. “Output” 140 further includes “Configurations of Applications” 143 which are required configurations of respective ones of one or more applications to obtain the expected performances. “Output” 140 further includes “Configurations of Networks” 144 which are required configurations for respective ones of one or more networks to obtain the expected performances of the one or more applications along the best route.

“Travel Distance Estimation” 111 (included in “Routing Service” 110 of “System” 100) uses information form “Map” 131 (included in “Input” 130) to compute distances of travelling by a vehicle via respective ones of possible routes. Results of the computation by “Travel Distance Estimation” 111 may be a weighted directed graph, in which weights represent travel distances in a road network.

“Environment Estimation” 112 (included in “Routing Service” 110 of “System” 100) uses “Environmental Conditions” 132 (included in “Input” 130) to compute metrics relevant to mobility routing of a vehicle. The output of “Environment Estimation” 112 may be one or more weighted directed graphs reflecting different variables that affect mobility. For example, the variables may be travel time and risk levels associated to roads. The variables may be any environmental condition that can be compared to a user's preference; for example, a greater weight is given to a wide lane of a road over a narrow one.

“Application QoS Estimation” 113 uses “Mobile Network Model” 133 (included in “Input” 130) and “QoS Requirements of Applications” 136 (included in “Input” 130) to estimate QoS levels that may be obtained for respective ones of the applications over an area containing all potential vehicle routes. For example, “Application QoS Estimation” 113 generates a directed graph with binary weights representing a road network in which “1” and “0” weights represent whether a minimum bitrate required by an application is guaranteed or not for the corresponding links (road), respectively. In another example, “Application QoS Estimation” 113 generates a heatmap that divides the map in regions with different latency levels for different applications.

“Settings and Configurations” 114 are determined based on “Travel Distance Estimation” 111, “Environment Estimation” 112, “Application QoS Estimation” 113, and “User Preferences” 134 (included in “Input” 130). The settings are parameters, properties, and/or attributes that can be set, while configurations are generally particular arrangements or interconnections of the modules. “Constraints” 115 are derived from “Origination, Destination, and Waypoints” 135 (included in “Input” 130) and “QoS Requirements of Applications” 136 (included in “Input” 130).

“Multi-Objective Optimization” 116 calculates an optimal route (i.e., “Route” 141 in “Output” 140) that is suggested for a user of a vehicle, given both “Constraints” 115 and “Settings and Configurations” 114. “Multi-Objective Optimization” 116 and “Constraints” 115 for an optimization algorithm are defined by combining incoming data structures that contain mobility metrics, application QoS metrics, and user preferences. Several optimization paradigms are applied in the multi-objective optimization. In some embodiments, math-programming approaches may be used and they aim to maximize route quality (e g, minimizing traveling time and/or minimizing traveling distance). Math-programming approaches include but not limited to exact approaches (e.g., column generation and Lagrangian decomposition), heuristics algorithms (e.g., genetic algorithm, ant colony optimization, tabu search, and simulated annealing), or machine learning approaches (e.g., reinforcement learning). In other embodiments, math-programming approaches may be time-dependent optimization, when a statistical characterization of traffic conditions is available. In yet other embodiments, math-programming approaches may be waypoint routing.

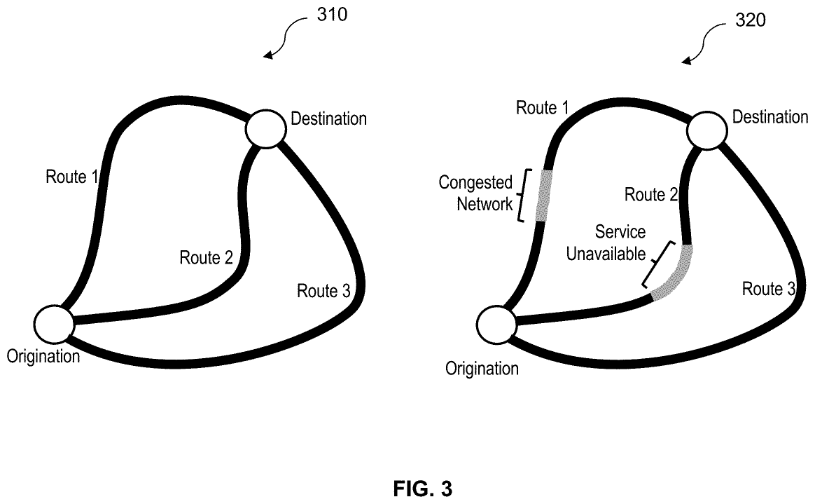

FIG. 3 is a diagram illustrating an example of considering network connectivity in determining an optimal route using multi-objective optimization, in accordance with one embodiment of the present invention. Diagram 310 illustrates three possible routes (route 1, route 2, and route 3) between two points (origination and destination). Diagram 320 illustrates the same three routes with some environment conditions such as network connectivity or service availability. As shown in diagram 320, route 1 has a section with a congested network, route 2 has a section without connectivity, and whole route 3 provides network connectivity. In determining an optimal route selected from route 1, route 2, and route 3, route 2 is selected if only mobility is considered; however, route 3 is selected if network connectivity in addition to mobility is considered.

After an optimal route is calculated by “Multi-Objective Optimization” 116, for a given optimal route provided by “Multi-Objective Optimization” 116 and given “QoS Requirements of Applications” 136 included in “Input” 130, “Application and “Network Configuration Planning” 120 generates “Expected Application QoS” 142, “Configurations of Applications” 143, and “Configurations of Networks” 144. For example, “Application and Network Configuration Planning” 120 determines expected latency that will be achieved by an application in every part of the optimal route. In another example, “Application and Network Configuration Planning” 120 determines a recommended maximum streaming bitrate for an application. In a further example, “Application and Network Configuration Planning” 120 determines a need for a mobile network to reserve resources for applications running in a vehicle in different areas.

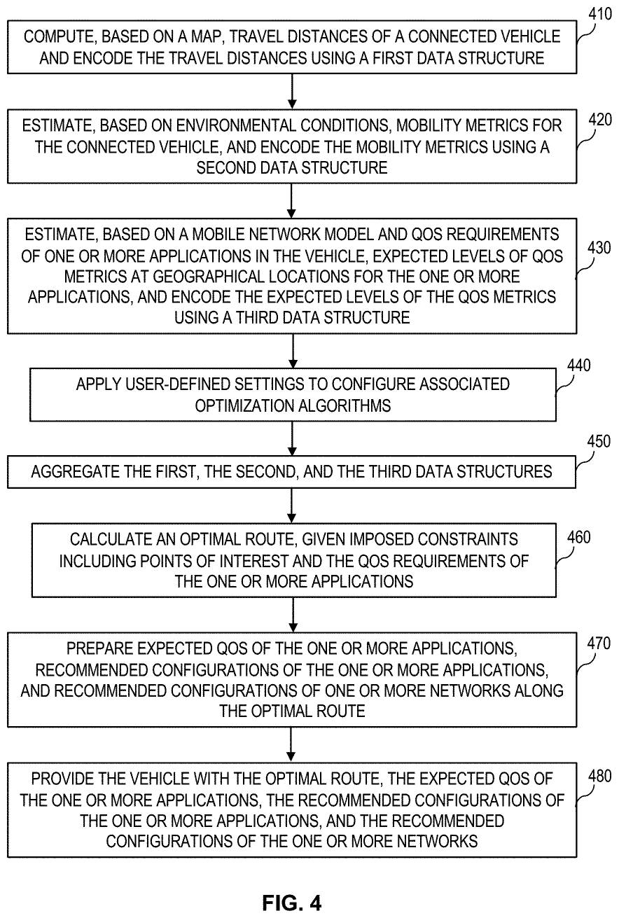

FIG. 4 presents a flowchart showing operational steps for joint optimization of vehicle mobility, communication networks, and required computing resources for a connected vehicle, in accordance with one embodiment of the present invention. At step 410, one or more computing devices or servers compute, based on a map, travel distances of a connected vehicle, and the one or more computing devices or servers encode the travel distances using a first data structure. In the embodiment shown in FIG. 1, “Travel Distance Estimation” 111 included in “System” 100 computes travel distances of the connected vehicle, according to “Map” 131 included in “Input” 130, and “Travel Distance Estimation” 111 encodes the travel distances using the first data structure such as a weighted directed graph in which weights represent travel distances in a road network.

At step 420, the one or more computing devices or servers estimate, based on environmental conditions, mobility metrics for the connected vehicle, and the one or more computing devices or servers encode the mobility metrics using a second data structure. In the embodiment shown in FIG. 1, “Environment Estimation” 112 in “System” 100 estimates mobility metrics for the vehicle and encode the mobility metrics using the second data structure, based on “Environmental Conditions” 132 included in “Input” 130. The second data structure may be one or more weighted directed graphs reflecting different variables (such as travel time and risk levels associated to roads) that affect mobility.

At step 430, the one or more computing devices or servers estimate, based on a mobile network model and QoS requirements of one or more applications in the vehicle, expected levels of QoS metrics at geographical locations for the one or more applications, and the one or more computing devices or servers encode the expected levels of the QoS metrics using a third data structure. In the embodiment shown in FIG. 1, “Application QoS Estimation” 113 in “System” 100 implements step 420. “Application QoS Estimation” 113 in “System” 100 uses “Mobile Network Model” 133 and “QoS Requirements of Applications” 136 to estimate the expected levels of QoS metrics; “Application QoS Estimation” 113 generates, for example, a directed graph with binary weights representing a road network.

At step 440, the one or more computing devices or servers apply user-defined settings to configure associated optimization algorithms. In the embodiment shown in FIG. 1, the user-defined settings refer to settings obtained from “Settings and Configurations” 114 in addition to constraints obtained from “Constraints” 115. These comprehend user inputs stored in “User Preferences” 134 and “Origination, Destination, and Waypoints” 135. In the embodiment shown in FIG. 1, “Multi-Objective Optimization” 116 is in charge of incorporating the user-defined settings into an optimization process. It should be mentioned that “Constraints” 115 may be user-defined in some embodiments while not user-defined in some other embodiments.

At step 450, the one or more computing devices or servers aggregate the first, the second, and the third data structures. The first data structure is used at step 410 to encode the travel distances, the second data structure is used at step 420 to encode the mobility metrics, and the third data structure is used at step 430 to encode the expected levels of the QoS metrics. In the embodiment shown in FIG. 1, “Multi-Objective Optimization” 116 is in charge of the aggregation of the first, the second, and the third data structures.

At step 460, the one or more computing devices or servers calculate an optimal route, given imposed constraints including points of interest and the QoS requirements of the one or more applications. In the embodiment shown in FIG. 1, “Multi-Objective Optimization” 116 calculates the optimal route, given “Constraints” 115 and “Settings and Configurations” 114.

At step 470, the one or more computing devices or servers prepare expected QoS of the one or more applications, recommended configurations of the one or more applications and recommended configurations of one or more networks along the optimal route. In the embodiment shown in FIG. 1, “Application and “Network Configuration Planning” 120 is in charge of preparation of the expected QoS of the one or more applications, the recommended configurations of the one or more applications, and the recommended configurations of the one or more networks along the optimal route.

At step 480, the one or more computing devices or servers provide the vehicle with the optimal route, the expected QoS of the one or more applications, the recommended configurations of the applications, and the recommended configurations of the one or more networks. In the embodiment shown in FIG. 1, “Multi-Objective Optimization” 116 provides “Route” 141 (included in “Output” 140), and “Application and “Network Configuration Planning” 120 provides “Expected Application QoS” 142, “Configurations of Applications” 143, and “Configurations of Networks” 144.

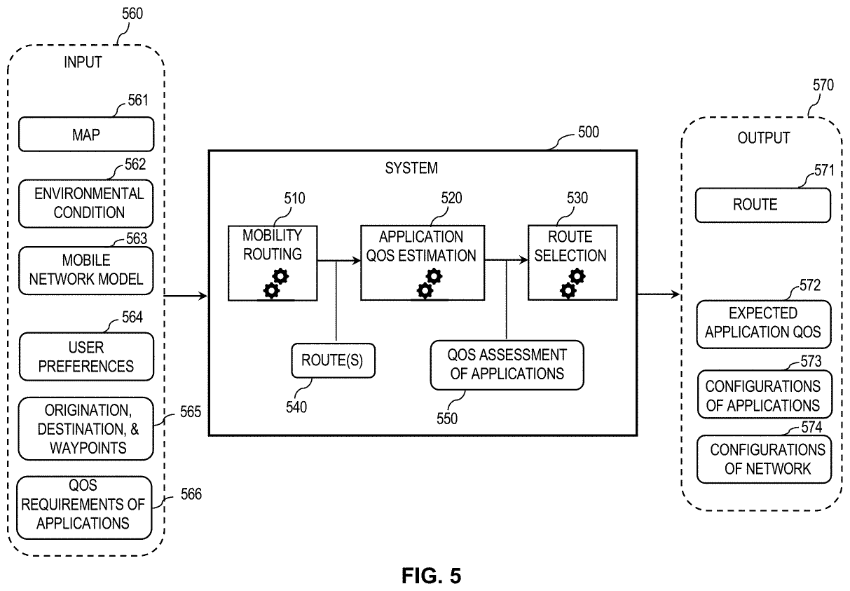

FIG. 5 is a systematic diagram illustrating “System” 500 for sub-optimal solution with lower computing complexity, in accordance with one embodiment of the present invention. Depending on specific inputs and constraints, the embodiment presented in FIG. 1 may be computationally expensive. The complexity in the embodiment shown in FIG. 1 can be reduced by using similar steps but daisy chaining them instead of executing them concurrently. This is achieved by computing a set of routes considering only mobility constraints and then selecting an optimal route that complies best with constraints of one or more mobile networks and one or more applications. The result of the embodiment shown in FIG. 5 is not globally optimal anymore, but it is a practical solution for the problem. “System” 500 includes “Mobility Routing” 510, “Application QoS Estimation” 520, and “Route Selection” 530. “System” 500 receives “Input” 560 and provides “Output” 570.

“Input” 560 includes “Map” 561, “Environmental Conditions” 562, “Mobile Network Model” 563, “User Preferences” 564, “Origination, Destination, and Waypoints” 565, and “QoS Requirements of Applications” 566. All items of “Input” 560 are similar to items of “Input” 130 shown in FIG. 1. For sake of brevity, the detailed descriptions of the items of “Input” 560 can be found in detailed description of the items of “Input” 130 shown in FIG. 1. The detailed description of the items of “Input” 130 shown in FIG. 1 are give in previous paragraphs with reference to FIG. 1.

“Output” 570 includes “Route” 571 which is a best route for a connected vehicle and recommended by “System” 500. “Output” 570 further includes “Expected Application QoS (Quality of Service)” 572 which is the expected performance of respective ones of one or more applications in the connected vehicle and is forecasted by “System” 500. “Output” 570 further includes “Configurations of Applications” 573 which are required configurations of the one or more applications to obtain the expected performances. “Output” 570 further includes “Configurations of Networks” 574 which are required configurations for one or more networks to obtain the expected performances of the one or more applications along a best route. The items of “Output” 570 are similar to the items of “Output” 140 shown in FIG. 1.

Referring to FIG. 5, given an origin, a destination, waypoints if any, map, and environmental conditions, “Mobility Routing” 510 in “System” 500 calculates a set of possible routes for the connected vehicle. As shown in FIG. 5, “Mobility Routing” 510 generates “Route(s)” 540. Using the mobile network model, QoS requirements of applications, user preferences, etc., “Application QoS Estimation” 520 estimates QoS performance for each application in each route of the set of possible routes. As shown in FIG. 5, “Application QoS Estimation” 520 generates “QoS Assessment of Applications” 550. With information generated by “Mobility Routing” 510 and “Application QoS Estimation” 520, “Route Selection” 530 selects an optimal route from the set of possible routes. The optimal route may be accompanied with suggested configurations of the one or more applications for a user of the connected vehicle and configurations of one or more networks for network or service operators.

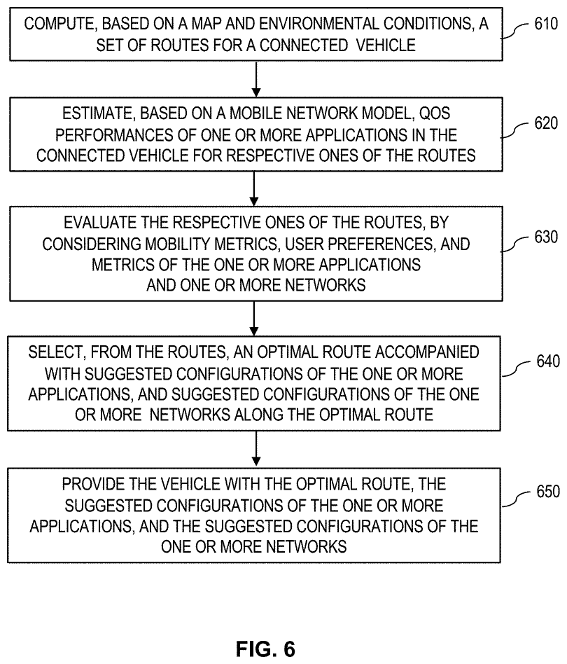

FIG. 6 presents a flowchart showing operational steps of sub-optimal solution with lower computing complexity, in accordance with one embodiment of the present invention. At step 610, one or more computing devices or servers compute, based on a map and environmental conditions, a set of routes for a connected vehicle. The set of routes are feasible or desirable routes for the connected vehicle travelling from the origin to the destination (maybe through waypoints). In the embodiment shown in FIG. 5, “Mobility Routing” 510 in “System” 500 computes the set of routes. In some embodiments, the one or more computing devices or servers may read a set of routes given or input by a user or a third party.

At step 620, one or more computing devices or servers estimate, based on a mobile network model, QoS performances of one or more applications in the connected vehicle for respective ones of the routes. In the embodiment shown in FIG. 5, “Application QoS Estimation” 520 in “System” 500 estimates the QoS performances for the one or more applications in respective ones of the routes.

At step 630, one or more computing devices or servers evaluate the respective ones of the routes, by considering mobility metrics, user preferences, and metrics of the one or more applications and one or more networks. In the embodiment shown in FIG. 5, “Route Selection” 530 in “System” 500 processes the evaluation of the respective ones of the routes. In the evaluation of the respective ones of the routes, the mobility metrics include but not limited to distance, time, traffic, and fuel or battery consumption; the user preferences include but not limited to preferred applications and preferred driving styles; and metrics of the applications and the networks include but not limited to estimated QoS for each application.

At step 640, one or more computing devices or servers select, from the routes, an optimal route accompanied with suggested configurations of the one or more applications, and suggested configurations of the one or more networks along the optimal route. In the embodiment shown in FIG. 5, “Route Selection” 530 in “System” 500 implements step 640. At step 650, one or more computing devices or servers provide the vehicle with the optimal route, the suggested configurations of the one or more applications, and the suggested configurations of the one or more networks.

FIG. 7 is a diagram illustrating components of computing device or server 700, in accordance with one embodiment of the present invention, in accordance with one embodiment of the present invention. It should be appreciated that FIG. 7 provides only an illustration of one implementation and does not imply any limitations with regard to the environment in which different embodiments may be implemented.

Referring to FIG. 7, computing device or server 700 includes processor(s) 720, memory 710, and tangible storage device(s) 730. In FIG. 7, communications among the above-mentioned components of computing device or server 700 are denoted by numeral 790. Memory 710 includes ROM(s) (Read Only Memory) 711, RAM(s) (Random Access Memory) 713, and cache(s) 715. One or more operating systems 731 and one or more computer programs 733 reside on one or more computer readable tangible storage device(s) 730.

Computing device or server 700 further includes I/O interface(s) 750. I/O interface(s) 750 allows for input and output of data with external device(s) 760 that may be connected to computing device or server 700. Computing device or server 700 further includes network interface(s) 740 for communications between computing device or server 700 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 8, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality for joint optimization of vehicle mobility, communication networks, and computing resources for a connected vehicle.

What is claimed is:

1. A computer-implemented method for optimizing vehicle mobility, communication networks, and required computing resources for a connected vehicle, the method comprising:
applying user-defined settings to configure associated optimization algorithms;
aggregating data structures related to traveling distances, mobility metrics, and expected levels of Quality of Service (QoS) for one or more applications in a connected vehicle;
calculating an optimal route, given imposed constraints including points of interest and QoS requirements of the one or more applications;
preparing expected QoS of the one or more applications, recommended configurations of the one or more applications, and recommended configurations of one or more networks along the optimal route; and
providing the connected vehicle with the optimal route, the recommended configurations of the one or more applications, and the recommended configurations of the one or more networks.

2. The computer-implemented method of claim 1, further comprising:
based on map, computing the traveling distances, and encoding the traveling distances using a first data structure;
based on environmental conditions, estimating the mobility metrics, and encoding the mobility metrics using a second data structure; and
based on a mobile network model and QoS requirements of the one or more applications in the connected vehicle, estimating the expected levels of QoS at geographical locations and encoding the expected levels of QoS using a third data structure.

3. The computer-implemented method of claim 2, wherein the environmental conditions include variables that affect mobility of the connected vehicle.

4. The computer-implemented method of claim 2, wherein the mobile network model is a function providing estimations of one or more QoS metrics of the one or more networks along routes, wherein the QoS requirements of the one or more applications include latency, constant or variable bitrate, required computation time, and storage.

5. The computer-implemented method of claim 1, wherein the user-defined settings are determined based on travel distance estimation, environment estimation, application QoS estimation, and user preferences.

6. The computer-implemented method of claim 5, wherein the user preferences include at least one of a level of autonomous driving, a vehicle type, a preferred arrival and departure time, and preferred applications in the connected vehicle.

7. A computer program product for optimizing vehicle mobility, communication networks, and required computing resources for a connected vehicle, the computer program product comprising a computer readable storage medium having program instructions embodied therewith, the program instructions executable by one or more processors, the program instructions executable to:
apply user-defined settings to configure associated optimization algorithms;
aggregate data structures related to traveling distances, mobility metrics, and expected levels of Quality of Service (QoS) for one or more applications in a connected vehicle;
calculate an optimal route, given imposed constraints including points of interest and QoS requirements of the one or more applications;
prepare expected QoS of the one or more applications, recommended configurations of the one or more applications, and recommended configurations of one or more networks along the optimal route; and
provide the connected vehicle with the optimal route, the recommended configurations of the one or more applications, and the recommended configurations of the one or more networks.

8. The computer program product of claim 7, further comprising the program instructions executable to:
based on map, compute the traveling distances and encoding the traveling distances using a first data structure;
based on environmental conditions, estimate the mobility metrics and encoding the mobility metrics using a second data structure; and
based on a mobile network model and QoS requirements of the one or more applications in the connected vehicle, estimate the expected levels of QoS at geographical locations and encoding the expected levels of QoS using a third data structure.

9. The computer program product of claim 8, wherein the environmental conditions include variables that affect mobility of the connected vehicle.

10. The computer program product of claim 8, wherein the mobile network model is a function providing estimations of one or more QoS metrics of the one or more networks along routes, wherein the QoS requirements of the one or more applications include latency, constant or variable bitrate, required computation time, and storage.

11. The computer program product of claim 7, wherein the user-defined settings are determined based on travel distance estimation, environment estimation, application QoS estimation, and user preferences.

12. The computer program product of claim 11, wherein the user preferences include at least one of a level of autonomous driving, a vehicle type, a preferred arrival and departure time, and preferred applications in the connected vehicle.

13. A computer system for optimizing vehicle mobility, communication networks, and required computing resources for a connected vehicle, the computer system comprising one or more processors, one or more computer readable tangible storage devices, and program instructions stored on at least one of the one or more computer readable tangible storage devices for execution by at least one of the one or more processors, the program instructions executable to:
apply user-defined settings to configure associated optimization algorithms;
aggregate data structures related to traveling distances, mobility metrics, and expected levels of Quality of Service (QoS) for one or more applications in a connected vehicle;
calculate an optimal route, given imposed constraints including points of interest and QoS requirements of the one or more applications;
prepare expected QoS of the one or more applications, recommended configurations of the one or more applications, and recommended configurations of one or more networks along the optimal route; and
provide the connected vehicle with the optimal route, the recommended configurations of the one or more applications, and the recommended configurations of the one or more networks.

14. The computer system of claim 13, further comprising the program instructions executable to:
based on map, compute the traveling distances and encoding the traveling distances using a first data structure;
based on environmental conditions, estimate the mobility metrics and encoding the mobility metrics using a second data structure; and
based on a mobile network model and QoS requirements of the one or more applications in the connected vehicle, estimate the expected levels of QoS at geographical locations and encoding the expected levels of QoS using a third data structure.

15. The computer system of claim 14, wherein the environmental conditions include variables that affect mobility of the connected vehicle.

16. The computer system of claim 14, wherein the mobile network model is a function providing estimations of one or more QoS metrics of the one or more networks along routes, wherein the QoS requirements of the one or more applications include latency, constant or variable bitrate, required computation time, and storage.

17. The computer system of claim 13, wherein the user-defined settings are determined based on travel distance estimation, environment estimation, application QoS estimation, and user preferences.

18. The computer system of claim 17, wherein the user preferences include at least one of a level of autonomous driving, a vehicle type, a preferred arrival and departure time, and preferred applications in the connected vehicle.

19. A computer-implemented method for optimizing vehicle mobility, communication networks, and required computing resources for a connected vehicle, the method comprising:
computing a set of routes for a connected vehicle, based on a map and environmental conditions;
estimating, for respective ones of the routes, Quality of Service (QoS) performances of one or more applications in the connected vehicle, based on a mobile network model;
evaluating the respective ones of the routes, by considering mobility metrics, user preferences, and metrics of the one or more applications and one or more networks;
selecting, from the set of the routes, an optimal route accompanied with suggested configurations of the one or more applications, and suggested configurations of the one or more networks along the optimal route; and
providing the connected vehicle with the optimal route, the suggested configurations of the one or more applications, and the suggested configurations of the one or more networks.

20. The computer-implemented method of claim 19, wherein the environmental conditions include variables that affect mobility of the connected vehicle.

21. The computer-implemented method of claim 19, wherein the mobile network model is a function providing estimations of one or more QoS metrics of the one or more networks along the routes.

22. The computer-implemented method of claim 19, wherein the mobility metrics include distance, time, traffic, and fuel or battery consumption, wherein the user preferences include preferred applications and preferred driving styles, wherein metrics of the one or more applications and the one or more networks include estimated QoS for the one or more applications.

23. A computer program product for optimizing vehicle mobility, communication networks, and required computing resources for a connected vehicle, the computer program product comprising a computer readable storage medium having program instructions embodied therewith, the program instructions executable by one or more processors, the program instructions executable to:
compute a set of routes for a connected vehicle, based on a map and environmental conditions;
estimate, for respective ones of the routes, Quality of Service (QoS) performances of one or more applications in the connected vehicle, based on a mobile network model;
evaluate the respective ones of the routes, by considering mobility metrics, user preferences, and metrics of the one or more applications and one or more networks;
select, from the set of the routes, an optimal route accompanied with suggested configurations of the one or more applications, and suggested configurations of the one or more networks along the optimal route; and
provide the connected vehicle with the optimal route, the suggested configurations of the one or more applications, and the suggested configurations of the one or more networks.

24. The computer program product of claim 23, wherein the environmental conditions include variables that affect mobility of the connected vehicle, wherein the mobile network model is a function providing estimations of one or more QoS metrics of the one or more networks along the routes.

25. The computer program product of claim 23, wherein the mobility metrics include distance, time, traffic, and fuel or battery consumption, wherein the user preferences include preferred applications and preferred driving styles, wherein metrics of the one or more applications and the one or more networks include estimated QoS for the one or more applications.
